(19) United States
(12) Patent Application Publication
(10) Pub. No.: US 2013/0083777 A1
(43) Pub. Date: Apr. 4, 2013

(54) Methods and Apparatuses for Supporting Handover of a PS Voice Call to a CS Voice Call by Using SRVCC Function

(71) Applicants: Gunnar Rydnell, Vastra Frolunda (SE); Roland Gustafsson, Bengtsfors (SE); Yong Yang, Molndal (SE)

(72) Inventors: Gunnar Rydnell, Vastra Frolunda (SE); Roland Gustafsson, Bengtsfors (SE); Yong Yang, Molndal (SE)

(73) Assignee: TELEFONAKTIEBOLAGET L M ERICSSON (PUBL), Stockholm (SE)

(21) Appl. No.: 13/704,208

(22) PCT Filed: Jun. 28, 2010
(86) PCT No.: PCT/EP2010/059138

§ 371 Date: Dec. 13, 2012

(51) Int. Cl. H04W 36/00

(52) U.S. Cl. CPC H04W 36/0022
USPC 370/331

(57) ABSTRACT

A method for a Mobile Control Node, MCN, supporting handover of a packet switched, PS, voice call of a given user entity anchored in a IP Multimedia Subsystem (IMS) to a circuit switched, CS, voice call, by using a Single Radio Voice Call Continuity, SRVCC, function, whereby, —after handover from PS to CS (102) voice call pertaining to a user entity, UE, which UE is in a suspended mode (305, 206/209/303), and upon receiving a SRVCC CS to PS resume request message (107) from a mobile switching centre, MSC, —issuing an explicit/implicit resume message (109, 306) to a packet gateway (PGW) node or a serving gateway (SGW) node, causing the UE to resume PS services (110). Further a method for a Mobile Switching Centre (MSC) supporting handover of a packet switched, PS, voice call of a given user entity (UE) via an SP Multimedia Subsystem (IMS) to a circuit switched, CS, voice call, by using a Single Radio Voice Call Continuity, SRVCC, function, wherein—after handover from PS to CS (103), and after detecting hang up or dropped call (106) issuing (209) a SRVCC CS to PS resume request message (107) to a MCN, thereby effecting the user entity to resume PS services of the voice call for a given user entity (UE).

### TECHNICAL FIELD

The present invention relates to packet switched and circuit switched voice calls and resuming of packet services. More particularly, the invention relates to the Single Radio Voice Call Continuity (SRVCC) function concerning handover from the Long Term Evolution (LTE) to Universal Terrestrial Mobile Telecommunication System Terrestrial Access Network (UTRAN) and to the GSM EDGE Radio Access Network (GERAN).

### BACKGROUND

As is known, voice services in LTE are packet switched and supported by the IMS system. However, as the LTE services can not be rolled out momentarily, there is a need to rely on 2G/3G based access technologies. One migration example is that LTE coverage becomes predominant in “islands” of densely populated areas, while existing 2G/3G services cover larger but less traffic intensive areas. As user entities move out of the LTE coverage areas, there is a need to handover the packet switched, PS, voice calls, to circuit switched, CS, voice calls of 2G/3G services. For this purpose, the Single Radio Voice Call Continuity (SRVCC) function was introduced in release 9 of the 3GPP and which function is dealt with in the following documents:

3GPP TS 23.401 v. 9.5.0, General Packet Radio Service (GPRS) enhancements for Evolved Universal Terrestrial Radio Access Network (E-UTRAN) access.

3GPP TS 29.280 v. 9. 3.0, Evolved Packet System (EPS); 3GPP Sv interface (MME to MSC, and SGSN to MSC) for SRVCC.

3GPP TS 23.216 v. 9.4.0 (2010-06), Single Radio Voice Call Continuity (SRVCC); Stage 2.

SRVCC (Single Radio Voice Call Continuity) is specified for SAE systems that provide IMS Voice in LTE. If radio coverage in LTE is lost during an IMS voice call in LTE, the SRVCC function makes it possible to hand off the voice call with service continuation to the 2G/3G CS side. The voice call is routed via an MSC but is still anchored in IMS.

The existing SRVCC function is based on NW (Network) signalling, which will enable handing over the voice call from LTE PS to 2G/3G CS service.

The Sv interface between the MME and the MSC Server is used for signalling from the MME to the MSC that handover (HO) is required. If the MSC accepts the request, it will set up the voice call towards the IMS side and will confirm to the MME that the HO is accepted. The MME will assure the RAN that the SRVCC HO is in progress and that the UE shall reselect to a 2G/3G cell. if the UE, or the 2G/3G NW, does not support DTM (Dual Transfer Mode, DTM, allowing simultaneous transfer of CS voice and PS data over the same radio channel (ARFCN)), the PS service will be suspended during the CS call. The term suspended means in this context that the UE is temporarily unavailable for PS traffic. The UE will be suspended in the MME, in the SGW and even in the PGW (since charging is done in the PGW). This means that any incoming packets to the UE will be discarded in the PGW. In case of non-DTM, after the call is finished and the UE hangs up, the UE will resume the PS service by reselecting to LTE (or possibly stay in 2G/3G by the choice of the UE) and making it-self known to the NW by sending a RAU/TAU ([Traffic Area Update) or some other NAS message. Non-DTM, or single radio, means that the UE or the NW, or both are not capable of handling dual transfer.

One problem, identified by the inventors for the present document, with the current SRVCC solution is that the SRVCC procedure collides with the ISR (Idle Mode Signalling Reduction). In case the UE moves in IDLE between LTE or 2G/3G while staying in a pre-defined list of TA's and LA's, the UE may refrain from RAU/TAU signalling. In case of non-DTM (Dual Transfer Mode) SRVCC, the UE may go to a 2G/3G cell which is in the ISR RAU/TAU list and therefore the UE shall not send RAU after the voice call is finished. Another possible case is that the UE, after the voice call is hung up, may reselect LTE, but that the UE will select the same cell in which it was located before the SRVCC HO to 2G/3G was started. In this case, the UE may not do a TAU since it is in the same cell as before. Hence, the UE may have moved back to LTE, but the NW is not aware of it. For other mobility use cases this is not a problem the UE will be paged in both systems. But in this case the UE is suspended and no paging will take place.

If the UE does not make itself known to the PS NW, i.e. to the MME or to the SGSN, the NW can not resume the UE. Incoming packets will be thrown away in the PGW and no paging of the UE will be done by the NW. This will lead to lost PS service and lost voice service (MMTEL/IMS services).

### SUMMARY

It is a first object of the invention to set forth at least one method for establishing for a UE being in IDLE mode to be reachable for packet services after a CS voice call has been dropped or hung up.

This object has been accomplished by a method for a Mobile Control Node, MCN, supporting handover of a packet switched, PS, voice call of a given user entity anchored in a IP Multimedia Subsystem (IMS) to a circuit switched, CS, voice call, by using a Single Radio Voice Call Continuity, SRVCC, function. The method for the Mobile Control Node further comprises the steps of—after handover from PS to CS voice call pertaining to a user entity, UE, which UE is in a suspended mode, and upon receiving a SRVCC CS to PS resume request message from a mobile switching centre, MSC, —sending an explicit/implicit resume message to a packet gateway (PGW) node or a serving gateway (SGW) node, causing the UE to resume PS services.

The above object has also been accomplished by a method for a Mobile Switching Centre (MSC) supporting handover of a packet switched, PS, voice call of a given user entity (UE) via an IP Multimedia Subsystem (IMS) to a circuit switched, CS, voice call, by using a Single Radio Voice Call Continuity, SRVCC, function. The method for the Mobile Switching Centre comprises moreover the steps of—after handover from PS to CS, and after detecting hang up or dropped call; —issuing a SRVCC CS to PS resume request message to a MCN, thereby effecting the user entity to resume PS services of the voice call for a given user entity (UE).

Alternatively, the above mentioned object has been accomplished by a:

Method for a Mobile Switching Centre (MSC) supporting handover of a packet switched, PS, voice call of a given user entity (UE) via an IP Multimedia Subsystem (IMS) to a circuit switched, CS, voice call, by using a Single Radio Voice Call Continuity, SRVCC, function. The method for a Mobile Switching Centre (MSC) further comprises the steps of,

after handover from PS to CS, and after detecting hang up or dropped call

wherein if an indication is provided to a SRVCC packet switch to circuit switch request message,

sending a SRVCC CS to PS Resume Request message to the MCN, and wherein if the indication is not provided,

ending the method such that the sending of the SRVCC CS to PS Resume Request message is prevented.

The latter method for a MSC is enabled by a method for a MCN, wherein the MCN is further adapted to issue a SRVCC PS to CS request message to a mobile switching centre (MSC) and wherein the MCN is adapted to add an indication to the SRVCC PS to CS request message, indicating to a MSC whether the UE was suspended in PS service and a SRVCC CS to PS resume request message is needed.

According to further aspects of the invention, regarding the method for the mobile control node it is further provided that the MCN issues the explicit/implicit resume message upon receiving a routing/traffic area update message from a user entity.

According to a further aspect, the MCN issues the explicit/implicit resume message upon receiving a service request message from a user entity.

According to a still further aspect, the MCN issues a SRVCC CS to PS resume response message upon receiving a SRVCC CS to PS resume request message from a mobile switching centre (MSC).

According to a further aspect regarding the method for the Mobile Switching Centre (MSC) supporting handover of a packet switched, PS, voice call of a given user entity (UE) via an IP Multimedia Subsystem (IMS) to a circuit switched, CS, voice call, by using a Single Radio Voice Call Continuity, SRVCC, function, there is provided a method comprising the further the steps of

the step of issuing the SRVCC CS to PS resume request message to the MCN, being further dependent on the MSC has received a RIL3-CC release message from a user entity and received a Release Complete message. Moreover, the step of—issuing the SRVCC CS to PS resume request message to the MCN, being further dependent on the MSC has received an ISUP release and received a RIL3-CC Release message.

According to the invention there is further provided mobile control node, MCN, the MCN comprising a control unit (CTRL UNIT) supporting handover of a PS (PS) voice call of a given user entity anchored in a IP Multimedia Subsystem (IMS) to a CS (CS) voice call over a Mobile Switching Centre (MSC), by using a Single Radio Voice Call Continuity function, whereby,

after handover from PS to CS voice call pertaining to a user entity, UE, which UE is in a suspended mode, and upon receiving a SRVCC CS to PS resume request message from a mobile switching centre, MSC, —issuing an explicit/implicit resume message to a packet gateway node or a serving gateway node, causing the UE to resume PS services.

According to a further aspect, the MCN is further adapted to issue a SRVCC PS to CS request message to a mobile switching centre and wherein the MCN is adapted to add an indication to the SRVCC PS to CS request message, indicating to a MSC whether the UE was suspended in PS service and a SRVCC CS to PS resume request message is needed.

According to the invention there is further provided a mobile Switching centre, MSC, comprising a control unit, user plane functionality and control plane functionality, the mobile switching centre supporting handover of a PS voice call of a given user entity via an IP Multimedia Subsystem (IMS) to a CS call over the Mobile Switching Centre (MSC), by using a Single Radio Voice Call Continuity function, whereby, —after handover from PS to CS, and after detecting hang up or dropped call—issuing a SRVCC CS to PS resume request message to a MCN, thereby effecting the user entity to resume PS services of the voice call for a given user entity.

According a further aspect of the invention regarding the mobile Switching centre if an indication is provided to the SRVCC packet switch to circuit switch request message, the MSC is adapted to

sending the SRVCC CS to PS Resume Request message to the MCN, and wherein if the indication is not provided,

ending the procedure such that the sending of the SRVCC CS to PS Resume Request message is prevented.

In case the UE moves in IDLE between LTE or 2G/3G while staying in a pre-defined list of TA's and LA's, the UE may refrain from RAU/TAU signalling. In case of non-DTM (Dual Transfer Mode) SRVCC, the UE may go to a 2G/3G cell which is in the ISR RAU/TAU list. However, according to the invention, the UE wiil be ready to resume packet services.

Further advantages of the invention will appear from the following detailed description of the invention.

### BRIEF DESCRIPTION OF THE DRAWINGS

FIG. 1 shows an exemplary handshake diagram according to first embodiments of a mobile control node, MCN, (that is a, MME, SGSN or a MME-SGSN) and a MSC according to the invention, wherein existing signalling according to FIG. 6.2.2.1-1 of 3GPP TS 23.216 V9.4.0 (2010-06) is indicated in brackets,

FIG. 2 shows a flow diagram for a method relating to a first embodiment of a MSC according to the invention supporting the FIG. 1 scenario,

FIG. 3 shows a flow diagram for a method relating to a second embodiment of a MSC according to the invention supporting the FIG. 1 scenario,

FIG. 4 shows a flow diagram for a method relating to a first embodiment of a MCN according to the invention working together with the FIG. 2 MSC, supporting the FIG. 1 scenario,

FIG. 5 shows a flow diagram for a method relating to a second embodiment of a MCN according to the invention working together with the FIG. 3 MSC, supporting the FIG. 1 scenario,

FIG. 6 shows an embodiment of a MSC according to the invention, and

FIG. 7 shows an embodiment of a MCN according to the invention.

### DETAILED DESCRIPTION OF PREFERRED EMBODIMENTS OF THE INVENTION

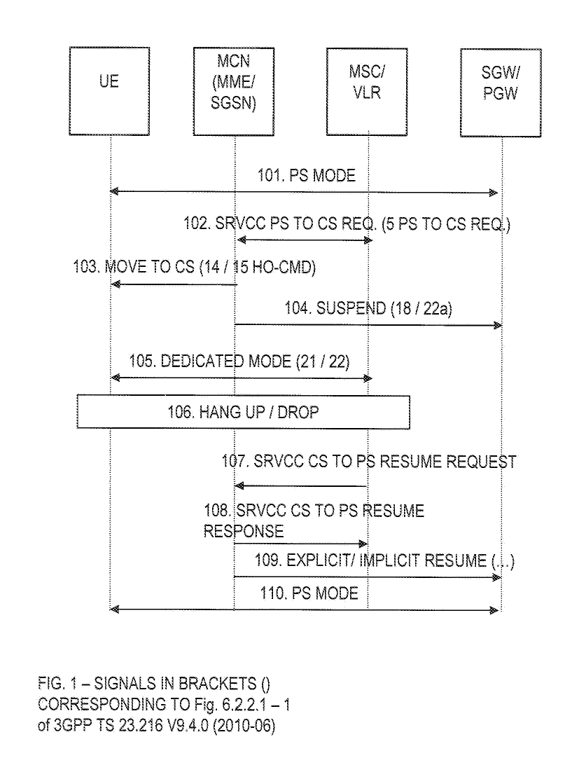

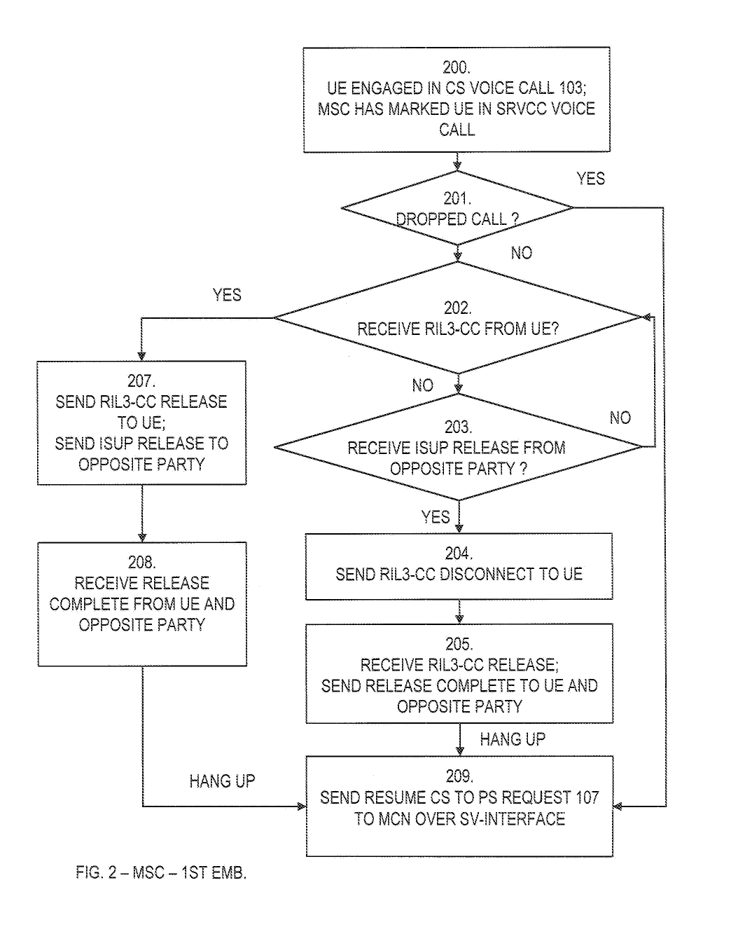

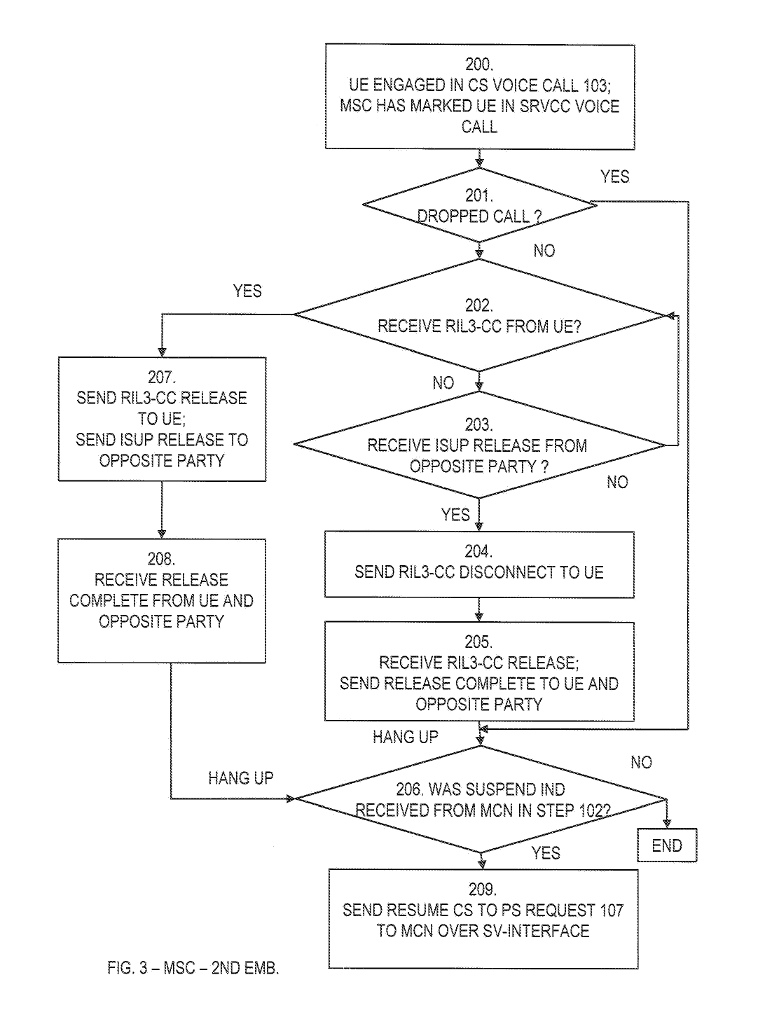

FIG. 1 shows an exemplary handshake diagram according to first embodiments of a mobile control node, MCN (that is a, Mobility Management Entity MME, a serving gateway support node, SGSN or a combined MME-SGSN node), and a mobile switching centre, MSC, according to the invention. In FIG. 2, a first embodiment of a method pertaining mobile switching centre (MSC) method according to the invention is shown and in FIG. 3 a first embodiment of a method for MCN according to the invention is shown adapted to corporate with the method shown in FIG. 2 for a MSC.

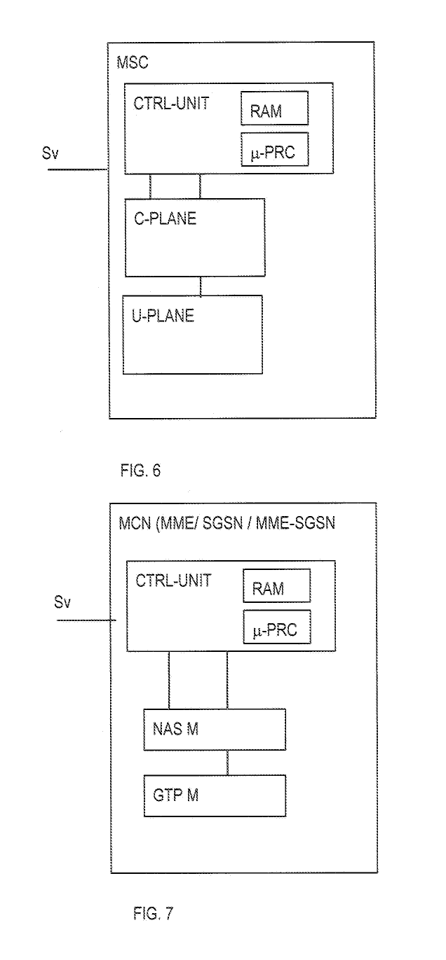

In FIG. 1, the signalling according to the invention is shown in the context of the existing signalling according to FIG. 6.2.2.1-1 of 3GPP TS 23.216 V9.4.0 (2010-06) “SRVCC from E-UTRAN t6o GERAN without DTM support” which is indicated in brackets. In FIG. 1 messages 101-106 illustrate known signals according to the prior art procedure. Also the explicit/implicit resume message 109 illustrated in FIG. 1 from MME to SGW/PGW is not shown in the FIG. 6.2.2.1-1 “SRVCC from E-UTRAN to GERAN without DTM support” in 23.216 but mentioned in the text to the figure.

As an example, as a starting point, the PS service mode is initiated, 101. In this situation, the PS service is ongoing in EPC/LTE and voice over LTE (MMTel) is done on one bearer, possibly in parallel with e.g. packet based services such as web surfing on some other bearer. The user may move out of the radio coverage of the LTE base station, whereby the radio network (NW) requests that handover (HO) is made to circuit switched GERAN, so that the voice call can continue.

The MSC Server has an interface denoted Sv which is specified by 3GPP in TS 29.280, which interface is associated with a GTP-like protocol. The Sv interface is used for initiating the SRVCC (Single Radio Voice Call Continuity) function. A SRVCC packet switch PS to circuit switch CS request is signalled, 102, from the MCN to the MSC Server (or Visitors Location Register (VLR)), indicating that the UE needs to hand-over (HO) the voice call to the CS operation. The MSC signals initiation of session transfer to IMS.

The MCN instructs the UE to move to CS service, 103, and issues suspend messaging, 22. As regards the MCN, the MCN instructs the SGW/PGW to perform bearer handling and suspension, 104. The suspend message indicates that no PS and CS services may appear at the same time. Then, there follows some signalling concerning a dedicated mode, 105. When the user entity e.g. after some time needs to finish the voice service, a hang up message 106 is sent from the UE to the MSC. Alternatively, the other party participating in the voice call hangs up. As a still further alternative, although seldom appearing, the voice call is dropped.

According to a first aspect of the invention, a resume function is provided which effectuates for a UE being in IDLE mode to be reachable for packet services after a CS voice call has been dropped or hung up, since the non-DTM (single radio) service will subsequently be available for PS services.

According to one aspect the resume function involves that a specific signalling message, SRVCC CS to PS resume request, 107, is provided from the MSC to the MCN. Moreover, there is provided a further specific signal denoted SRVCC CS to PS resume response message, 108, from the MCN to the MSC.

According to the invention, in order to resume the PS voice services for the UE, even if the UE is silent due to ISR (Mode Signalling Reduction) or other reasons, the MSC Server takes the initiative to “resume” the PS voice service via signal 107.

When the voice call is finished, this situation is made known to the MSC Server via reception of the hang up message, 106. However, according to the 3GPP documents mentioned above, there is no signalling on the Sv interface once the voice call has terminated.

According to the first embodiment of the invention, it is not needed that the MSC knows whether the UE is suspended. It is sufficient that the MSC signals to the MCN hat the CS call is finished and as the MCN is aware of whether the UE is in suspended mode or not, it can initiate the resume procedure if needed.

The present invention is applicable also to the non-ISR (non-Idle Mode Signalling Reduction) case, when the UE comes back to LTE with the same TA as before immediately after a CS call. Since the TA is either not changed or changed but only within the TA list, the UE may not perform a TAU to recover from the suspend state. The UE may wait and perform it only when there is a need such as if a Periodic TAU timer expired or if uplink data is pending.

For SRVCC from E-UTRAN, the MSC needs to send the Resume message to MCN, while in SRVCC from UTRAN, the MSC needs to send resume to SGSN (NOT SHOWN). The MSC will know from where the PS to CS request 102 came in the first place and will send it there.

Specific messages are specified on the Sv interface according to the TS 29.280, section 5.2. A Sv Message Type value and a Message is defined and coded per GTP (GPRS tunnel protocol) in 3GPP TS 29.274.

It is noted that messages for Message Type value 0-31 are specified as shown in the table below while messages for 32-255 are reserved for GTPv2 according to 3GPP TS 29.274

According to an embodiment of the invention, the SRVCC CS to PS Resume Req/Resp (107/108) are inserted as shown in the table below adding the signal under Message, Type 31 (107 in FIG. 1) and (108 in FIG. 1):

| Message Type | | |
|---|---|---|
| value (Decimal) | Message | Reference |
| 0 | Reserved | 3GPP TS 29.274 [3] |
| 1 | Echo Request | 3GPP TS 29.274 [3] |
| 2 | Echo Response | 3GPP TS 29.274 [3] |
| 3 | Version Not Supported Indication | 3GPP TS 29.274 [3] |
| 4-24 | Reserved for S101 interface | 3GPP TS 29.274 [3] |
| 25 | SRVCC PS to CS Request | 5.2.2 |
| 26 | SRVCC PS to CS Response | 5.2.3 |
| 27 | SRVCC PS to CS Complete | 5.2.4 |
| | Notification | |
| 28 | SRVCC PS to CS Complete | 5.2.5 |
| | Acknowledge | |
| 29 | SRVCC PS to CS Cancel | 5.2.6 |
| | Notification | |
| 30 | SRVCC PS to CS Cancel | 5.2.7 |
| | Acknowledge | |
| 31 | SRVCC CS to PS Resume | — |
| | Req/Resp (107/108) | |
| 32-255 | Reserved for GTPv2 | 3GPP TS 29.274 [3] |

It should be noted, the above implementation of signalling is one possibility and that alternatively, the indications in question can be sent in an existing message (implicit message) with a new use, e.g. including a new IE (information element) that changes the meaning of an existing message. Some existing message between MME-SGW-PGW, could be modified. For instance some message among messages types 25-30 could also be used for signalling messages 107 and 108 according to the invention.

FIG. 2 shows one embodiment of a method for a MSC according to the invention adapted to support the scenario shown in FIG. 1.

In step 200, the initial situation is that the UE is engaged in a CS voice call. The MSC has marked the UE as being in SRVCC voice call.

In step 201, it is determined whether a call is dropped. If yes proceed to step 209 below, if no to step 202.

In step 202, it is checked whether a RIL3-CC (NAS signalling indicating that the user entity wants to hang up) is received from the UE. If No, the method proceeds to step 203, if yes, to step 207.

In step 207, the MSC transmits a RIL3_CC release message to the UE and sends an ISUP release to the remote party at the other end communicating with the UE.

Thereafter, in step 208, the MSC proceeds when it receives a release complete from the UE and the opposite party to the call. After this step, the method proceeds to step 209, explained below.

In step 203, it is checked whether an ISUP release (SS7/CS signalling indicating the other party to the call wants to hang up) is received from the opposite party to the call of the conversation for the UE, that is, from a remote party. If no, the method goes back to step 202, if yes, the method proceeds to step 204.

In step 204, the MSC sends a RIL3-CC disconnect to the UE.

In step 205, the method proceeds when the MSC receives a RIL3-CC release. The MSC sends a release complete message to the UE and the opposite party to the call.

Then in step 209, the MSC transmits a SRVCC resume CS to PS request message 107 to the MCN over the Sv interface. It is seen that if the call is hung up or dropped, the message Resume CS to PS request 107 is sent to the MCN.

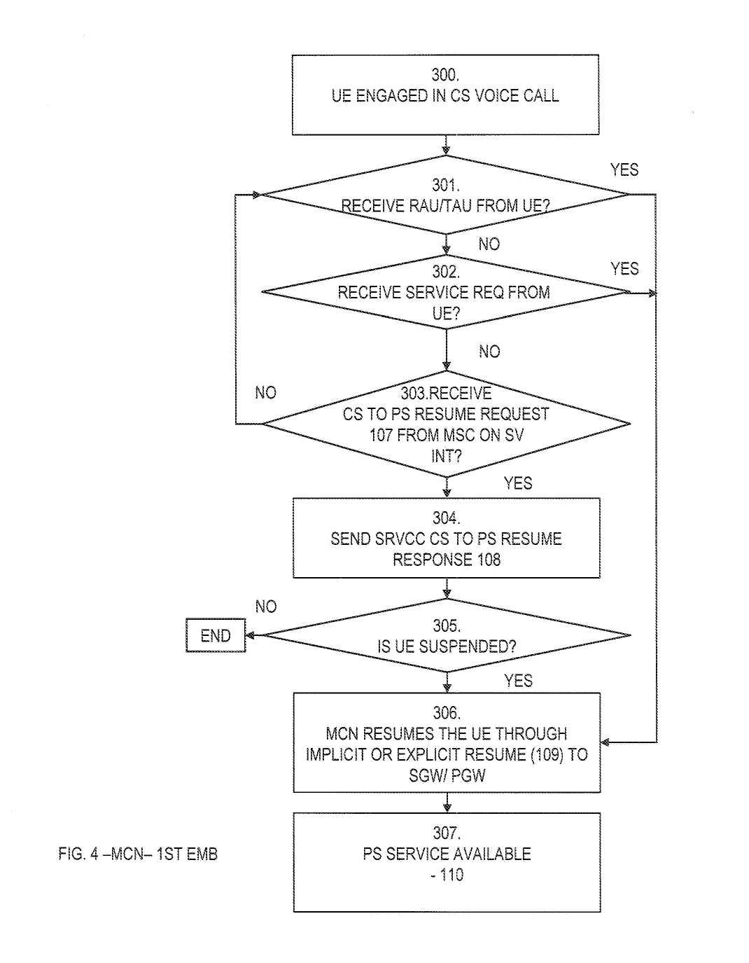

FIG. 4 shows a first embodiment of a method for a MCN according to the invention interacting with the first embodiment of the method for a MSC according to the invention.

In step 300, the initial situation is that the UE is engaged in a CS voice call and the MSC has marked the UE to be undertaking a SRVCC voice call.

In step 301, it is checked whether the MCN has received a routing area update or traffic area update from the UE, if yes the method proceeds to step 306, if no, it proceeds to step 302.

In step 302, it is checked whether the MCN has received a service request from UE. If yes, the method proceeds to step 306 below, if no, the method proceeds to step 303.

In step 303, it is checked whether the MCN has received a CS to PS resume request message 107 from the MSC on the SV interface.

If yes, the method proceeds to step 304, where the MCN acknowledges to the MSC the CS to PS resume request message 107 by issuing a SRVCC circuit switch to packet switch resume response, 108 and moving to step 305. If no, in step 304, the method proceeds to step 301.

In step 305, it the MCN examines whether the UE is suspended. If no the MCN method ends, while, if yes, it moves to step 306. In step 306, the MCN issues an implicit or explicit resume signal, 109, which signal per se is known in the art to the SGW/PGW.

Following the above signal, in step 305, the PS service is made available to the UE.

### Second Embodiment of the Invention

In FIG. 3 a second embodiment of a MSC method according to the invention is shown

It is possible that the MSC will send the SRVCC CS to PS Resume Request message 107 when the CS call is hung up in all use cases for the method shown in FIG. 2, even if the UE was not suspended. This will work because the MCN will know if the UE was suspended or not and can determine if a SRVCC CS to PS Resume Response message 108 is needed.

However, this method can result in unnecessary signalling, since in many cases, i.e. when DTM is implemented, the UE is not suspended. Therefore, according to a second embodiment of the invention, an indication is provided, e.g. a flag is added to the “SRVCC PS to CS Req” message, 102, from the MCN to the MSC, such that the MSC can know if a SRVCC CS to PS Resume CS to PS Request message 107 is needed. In this case, the MSC will only send the SRVCC CS to PS Resume Request message 107 to the MCN only if indicated to it. The suspend flag e.g. is added to the known “SRVCC PS to CS Request” message 102 shown in FIG. 1 as an additional optional IE.

In FIG. 3, the method of this further embodiment is shown. The method differs over the FIG. 2 method in that after step 205 or 208, the method moves to step 206 instead of 209.

In step 206, it is decided whether a suspend indication was received in step 102. If this is not the case, the method ends, thereby preventing sending the SRVCC CS to PS resume request message, whereas if the answer is yes, the method proceeds to step 209, sending the SRVCC resume CS to PS request, 107.

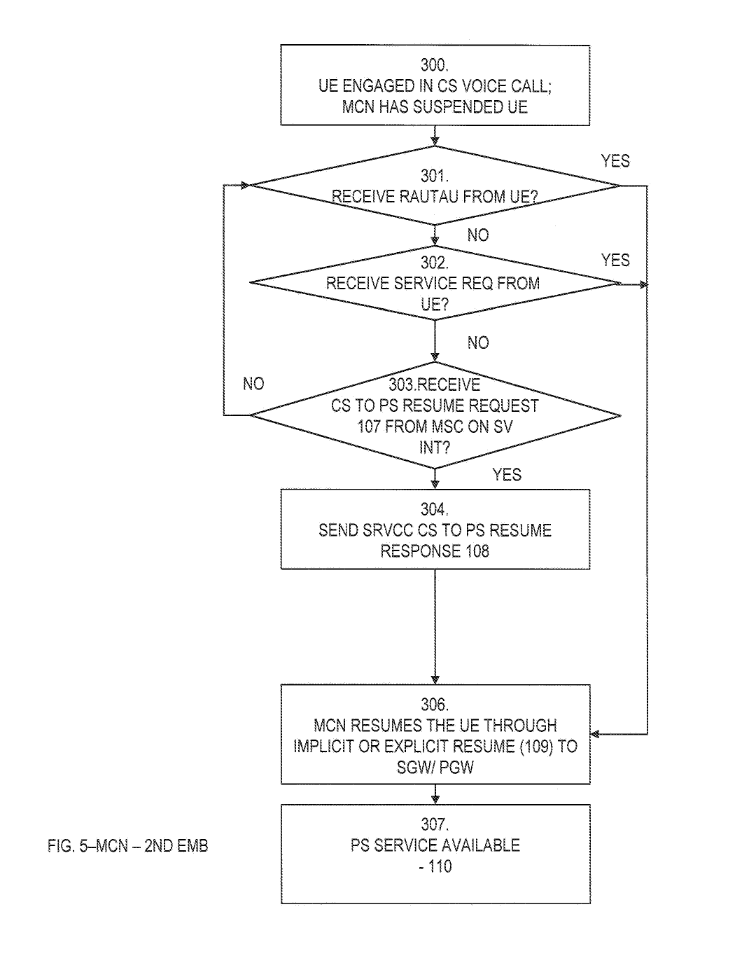

In FIG. 5, the corresponding method for the MCN is shown.

In step 300, the initial situation is that the UE is engaged in a CS voice call and the MSC has marked the UE to be undertaking a SRVCC voice call. For this embodiment, the MCN has suspended the UE.

In contrast to the method shown in FIG. 4, the step 305 is not provided, and the method goes from step 304 to 306.

The above embodiments may be implemented in a MSC and a MCN according to the following outline.

In FIG. 6, a MSC according to the invention is shown comprising control plane functionality, C-PLANE, and user plane functionality, U-PLANE, a control unit, CTRL-UNIT and an interface Sv. The control unit, CTRL-UNIT, comprising a RAM memory and a micro processor, μ-PRC, undertakes carrying out the method shown in FIG. 2 or 3.

In FIG. 7, a MCN according to the invention is shown. The MCN comprises a NAS signalling module, NAS M, a GTP signalling module GTP M, and a control unit, CTRL-UNIT. Moreover, there is provided a Sv interface. The control unit, CTRL-UNIT, comprising a RAM memory and a micro processor, μ-PRC, undertakes carrying out the method shown in FIG. 4 or 5.

It is seen that in case of suspended PS service for non-DTM SRVCC function in LTE, the UEs PS Service can be resumed by a pure NW operation, which need not involve the UE. In particular, the problem that arises because of ISR, when the UE may or may not signal to the NW after the call is finished, can be supported. No changes are needed to the UE implementation or to the specified ISR function. This makes the two functions SRVCC and ISR working independently from one another.

### ABBREVIATIONS

DTM Dual Transfer Mode

CS Circuit Switched

LTE Long Term Evolution

MME Mobility Management Entity

SAE System Architecture Evolution

SGW Serving Gateway

E-UTRAN Enhanced UMTS Terrestrial Radio Access Network

GW Gateway

HO HandOver

IMS IP Multimedia Subsystem

IMSI International Mobile Station Identity

IP Internet Protocol

ISR Idle Mode Signalling Reduction

MCN Mobile Control Node

NAS Non Access Stratum protocol

PGW PDN gateway

PS Packet Switched

TA Tracking Area

TAU Tracking Area Update

RAU Routing area update

MMTEL Multimedia Telephony Service

NW network

1.-16. (canceled)

17. A method implemented by a Mobile Control Node (MCN) operative to use a Single Radio Voice Call Continuity (SRVCC) function to support handover of a packet switched (PS) voice call of a given user equipment (UE) anchored in an IP Multimedia Subsystem (IMS) to a circuit switched (CS) voice call, and to support handover of the UE from CS services to PS services, the method comprising:
after handover of the voice call of the UE from PS to CS with the UE being in a suspended mode in which PS and CS data may not be simultaneously received by the UE, and upon the MCN receiving a SRVCC CS to PS resume request message from a Mobile Switching Center (MSC), the MCN issuing an explicit or implicit resume message to a packet gateway (PGW) node or a serving gateway (SGW) node to cause the UE to resume PS services;
wherein the MCN is a Mobility Management Entity (MME), a Serving Gateway Support Node (SGSN), or a combined MME/SGSN node.

18. The method of claim 17, further comprising issuing another explicit or implicit resume message upon receiving a routing area update or traffic area update message from the UE to cause the UE to resume PS services.

19. The method of claim 17, further comprising issuing another explicit or implicit resume message upon receiving a service request message from the UE to cause the UE to resume PS services.

20. The method of claim 17, further comprising issuing a SRVCC PS to CS request message to the MSC that includes an indication of whether the UE was suspended in a PS service and whether a SRVCC CS to PS resume request message is needed.

21. A method implemented by a Mobile Switching Center (MSC) supporting handover of a packet switched (PS) voice call of a given user equipment (UE) via an IP Multimedia Subsystem (IMS) to a circuit switched (CS) voice call, by using a Single Radio Voice Call Continuity (SRVCC) function, the method comprising:
after handover of the voice call from PS to CS, and after the MSC detects either hang-up or dropping of the voice call, the MSC sending a SRVCC CS to PS resume request message to a Mobile Control Node (MCN) to cause the UE to resume PS services;
wherein the MCN is a Mobility Management Entity (MME), a Serving Gateway Support Node (SGSN), or a combined MME/SGSN node.

22. A method implemented by a Mobile Switching Center (MSC) supporting handover of a packet switched (PS) voice call of a given user equipment (UE) via an IP Multimedia Subsystem (IMS) to a circuit switched (CS) voice call, by using a Single Radio Voice Call Continuity (SRVCC) function, the method comprising:
determining, after handover of the voice call from PS to CS, and after the MSC detecting hang up or dropping of the voice call, whether an indication has been received in a SRVCC PS to CS request message indicating that a SRVCC CS to PS resume request message is needed;
the MSC selectively sending, based on the determining, a SRVCC CS to PS Resume Request message to cause the UE to resume PS services to the MCN such that:
if the indication has been received, the MSC sends the SRVCC CS to PS Resume Request message;
if the indication has not been received, the MSC avoids sending the SRVCC CS to PS Resume Request;
wherein the MCN is a Mobility Management Entity (MME), a Serving Gateway Support Node (SGSN), or a combined MME/SGSN node.

23. The method of claim 22, wherein the determining is only performed if the MSC has received a RIL3-CC release message and a Release Complete message from the UE.

24. The method of claim 22, wherein the determining is only performed if the MSC has received an ISUP release message and a RIL3-CC Release message from the UE.

25. A Mobile Control Node (MCN) comprising:
a control unit operative to:
use a Single Radio Voice Call Continuity (SRVCC) function to support handover of a packet switched (PS) voice call of a given user equipment (UE) anchored in an IP Multimedia Subsystem (IMS) to a circuit switched (CS) voice call over a Mobile Switching Center (MSC); and
support handover of the UE from CS services to PS services;
wherein the MCN is configured to issue, after handover of the voice call of the UE from PS to CS with the UE being in a suspended mode in which PS and CS data may not be simultaneously received by the UE, and upon the MCN receiving a SRVCC CS to PS resume request message from the MSC, an explicit or implicit resume message to a packet gateway (PGW) node or a serving gateway (SGW) node to cause the UE to resume PS services;
wherein the MCN is a Mobility Management Entity (MME), a Serving Gateway Support Node (SGSN), or a combined MME/SGSN node.

26. The MCN of claim 25, wherein the MCN is further configured to issue a SRVCC PS to CS request message to the MSC that includes an indication of whether the UE was suspended in PS service and whether a SRVCC CS to PS resume request message is needed.

27. The MCN of claim 26, wherein the MCN is further configured to issue another explicit or implicit resume message upon receiving a routing area update or traffic area update message from the UE to cause the UE to resume PS services.

28. The MCN of claim 26, wherein the MCN is further configured to issue another explicit or implicit resume message upon receiving a service request message from the UE to cause the UE to resume PS services.

29. A Mobile Switching Center (MSC) comprising:
a control unit supporting user plane functionality and control plane functionality, and supporting handover of a packet switched (PS) voice call of a given user equipment (UE) via an IP Multimedia Subsystem (IMS) to a circuit switched (CS) voice call using a Single Radio Voice Call Continuity (SRVCC) function
wherein the MSC is configured to send, after handover of the voice call from PS to CS and after the MSC has detected hang up or dropping of the voice call, a SRVCC CS to PS resume request message to a Mobile Control Node (MCN) to cause the UE to resume PS services;
wherein the MCN is a Mobility Management Entity (MME), a Serving Gateway Support Node (SGSN), or a combined MME/SGSN node.

30. A Mobile Switching Center (MSC) comprising:
a control unit supporting user plane functionality and control plane functionality, and supporting handover of a packet switched (PS) voice call of a given user equipment (UE) via an IP Multimedia Subsystem (IMS) to a circuit switched (CS) voice call using a Single Radio Voice Call Continuity (SRVCC) function
wherein the MSC is configured to:
determine, after handover of the voice call from PS to CS, and after the MSC has detected hang up or dropping of the voice call, whether an indication has been received in a SRVCC PS to CS request message indicating that a SRVCC CS to PS resume request message is needed;
selectively send, based on the determining, a SRVCC CS to PS Resume Request message to cause the UE to resume PS services to the MCN such that:
if the indication has been received, the SRVCC CS to PS Resume Request message is sent;
if the indication has not been received, the MSC avoids sending the SRVCC CS to PS Resume Request;
wherein the MCN is a Mobility Management Entity (MME), a Serving Gateway Support Node (SGSN), or a combined MME/SGSN node.

31. The MSC of claim 30, wherein the determining is only performed if the MSC has received a RIL3-CC release message and a Release Complete message from the UE.

32. The MSC of claim 30, wherein the determining is only performed if the MSC has received an ISUP release message and a RIL3-CC Release message from the UE.
